(19) United States
(12) Patent Application Publication
(10) Pub. No.: US 2010/0229170 A1
(43) Pub. Date: Sep. 9, 2010

(54) HOST COMPUTER, MULTIPATH SYSTEM, PATH ASSIGNMENT METHOD, AND PROGRAM PRODUCT

(76) Inventor: YASUHITO TOHANA, Tokyo (JP)

Correspondence Address: Mr. Jackson Chen, 6535 N. STATE HWY 161, IRVING, TX, 75039, US

(21) Appl. No.: 12/698,571

(22) Filed: Feb. 2, 2010

(30) Foreign Application Priority Data
Mar. 6, 2009 (JP) 2009-052918

(51) Int. Cl. G06F 9/46; G06F 9/455

(52) U.S. Cl. 718/1; 718/100

(57) ABSTRACT

In a multipath system whereby a host computer having multiple logical partitions is connected to a system resource via multiple paths, and the multiple logical partitions share the system resource, I/O responsiveness is ensured even for the logical partition with less amount of I/O. A host computer of the present invention that is connected to the system resource via n (n>=2) number of paths includes multiple logical partitions that are accessible to the system resource and an assignment unit for assigning paths to the multiple logical partitions. The assignment unit assigns at least m (1<=m<n) number of path to one logical partition.

### INCORPORATION BY REFERENCE

This application is based upon and claims the benefit of priority from Japanese patent application No. 2009-052918, filed on Mar. 6, 2009, the disclosure of which is incorporated herein in its entirety by reference.

### BACKGROUND OF THE INVENTION

1. Field of the Invention

The present invention relates to a path assignment technique in a multipath system.

2. Description of Related Art

Various attempts have been made for improving the efficiency of a computer system including a host computer and a system resource (storage device, for example) used by the host computer.

For example, Japanese Unexamined Patent Application Publication No. 2008-257572 discloses a method to logically divide a storage device so as to create multiple logical partitions, and control each logical partition to operate as an individual and independent storage system. The proportion to divide into each logical partition is changed depending on the amount of access by the host computer. Then the resource of the storage device included in the logical partition with less accesses can be assigned to other logical partitions with more accesses, thereby enabling to efficiently use the storage resource.

Further, a multipath system whereby a host computer and a system resource are connected via multiple paths is well known in the art. The multipath system enables to duplicate paths and also distribute I/O (Input/Output) load. Various methods are proposed also for the construction and operation of such multipath system.

For example, Published Japanese Translation of PCT International Publication for Patent Application, No. 2002-533831 discloses a devised method to assign an I/O operation for reception/transmission between a host computer and a system resource to which one of multiple paths in a multipath system that uses the multiple paths at the same time. To be more specific, this method estimates a completion time of the current I/O operation performed by each path and assigns the next I/O operation to the path that completes the I/O operation fastest among the multiple paths. Then, the use efficiency of the multiple paths can be improved by the well known round-robin method that sequentially assigns I/O operations to the multiple paths and thereby achieving to improve the efficiency of the entire system.

Moreover, the Japanese Unexamined Patent Application Publication No. 2007-157089 discloses that, in a multipath system provided with a normally used path (which is a main path) and a path used in case of a failure in the main path (which is a sub path), the method to switch to the sub path when detecting a failure in the main path and also to block the main path until the failure is resolved.

If the main path is not blocked while the failure is generated, an access from the host computer to the storage device follows the steps of “access via the main path”, “cannot access due to a failure in the main path”, and “switch to the sub path”. The method disclosed in Japanese Unexamined Patent Application Publication No. 2007-157089 blocks the main path until restored. Thus while the main path is blocked, the access from the host computer to the system resource is always “an access via the sub path”. Therefore, the access efficiency while the problem is generated in the main path can be improved.

Moreover, there is also a well known multipath system whereby a host computer that includes multiple logical partitions configured for each of multiple OSs (Operating Systems) is connected to a system resource via multiple paths, and the multiple logical partitions share the system resource.

The present inventor has found a problem that in the multipath system whereby a host computer that includes multiple logical partitions is connected to a system resource via multiple paths, and the multiple logical partitions share the system resource, if there are variations in the amount of I/O of each logical partitions, the process of the entire system places more emphasis on a request from the logical partition with more amount of I/O. Thus the process of the application in the logical partition with less amount of I/O may be held up.

### SUMMARY

The present invention has been made in light of the abovementioned circumstances and provides a path assignment technique that ensures I/O responsiveness to the logical partition with less amount of I/O.

An exemplary aspect of an embodiment of the present invention is a host computer that is connected to a system resource via n (n>=2) number of paths that includes a plurality of logical partitions accessible to the system resource, and an assignment unit that assigns the paths to the plurality of logical partitions.

The assignment unit assigns at least m (1<=m<n) number of paths to one logical partition.

The host computer of the above exemplary embodiment may be replaced with an apparatus, a method, a multipath system comprising the host computer, and a program product for directing a computer to perform a path assignment process which is performed by the host computer. Those replacements are also effective as aspects of the present invention.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a pattern diagram of a multipath system for explaining the principle of the technique according to the present invention;

FIG. 2 illustrates a multipath system according to a first exemplary embodiment of the present invention;

FIG. 3 illustrates an example of an assignment table created by a path control driver in a server of the multipath system of FIG. 2;

FIG. 4 is a flowchart illustrating an assignment of paths by the path control driver in the server of the multipath system of FIG. 2;

FIG. 5 is a flowchart illustrating an update of the assignment table by the path control driver in the server of the multipath system of FIG. 2; and

FIG. 6 illustrates the multipath system according to a second exemplary embodiment of the present invention.

### EXEMPLARY EMBODIMENTS

For clarity of explanation, the description and the drawings below are omitted and simplified as appropriate. In the drawings, sections with similar configuration and function are denoted by the same symbols.

Each component described in the drawings as functional blocks for carrying out various processes can be made up of CPU, memory, and other circuit in terms of hardware. In terms of software, the components can be realized by program products loaded to the memory. Therefore, the person skilled in the art will understand that these functional blocks can be achieved by various forms such as only by hardware, software, or combination thereof, and it is not limited to any of them.

The principle of the path assignment technique according to the present invention is described before explaining specific exemplary embodiments of the present invention.

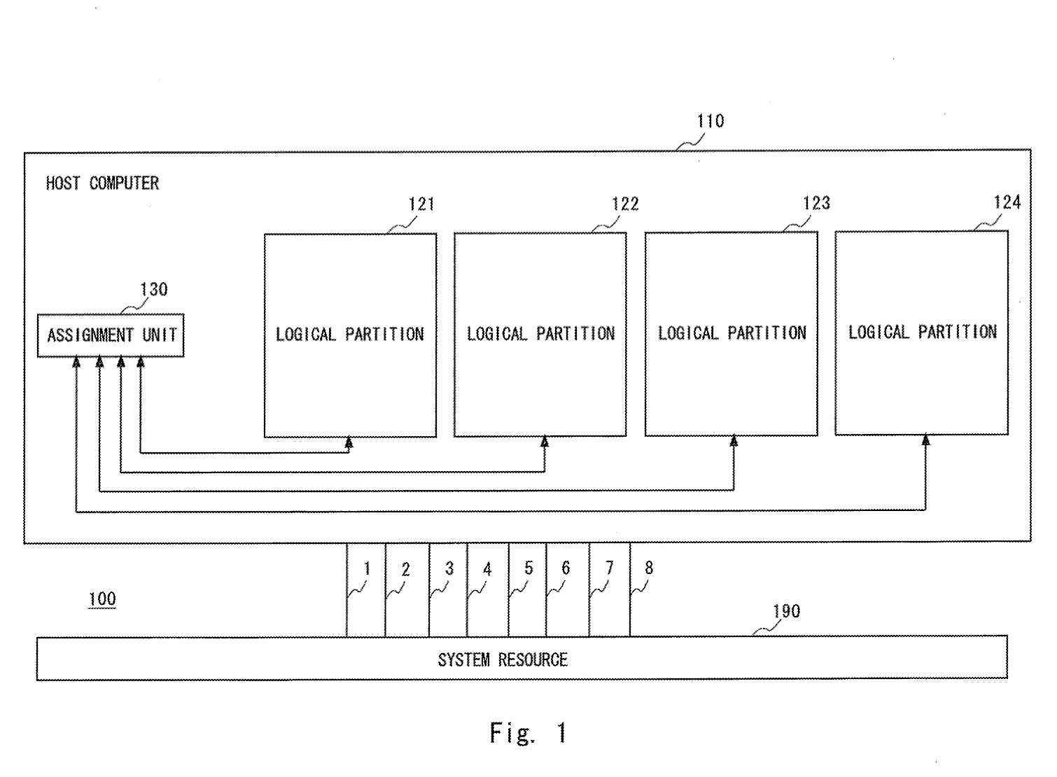

FIG. 1 is a pattern diagram of a multipath system 100 for explaining the principle of the present invention. The multipath system 100 is provided with a host computer 110, a system resource (storage device, for example) 190 used by the host computer 110, and multiple paths, for example 8 paths (paths 1 to 8), for connecting the host computer 110 and the system resource 190.

The host computer 110 is provided with multiple, for example 4, logical partitions (logical partitions 121 to 124) and an assignment unit 130 for assigning paths to the logical partitions 121 to 124.

The assignment unit 130 assigns at least m number of paths to each of the logical partitions. Note that m is more than or equal to 1 and less than the total number of the paths (8 in this example).

That is, at least m number of paths are assigned to each logical partition of the host computer 110 under any circumstances. Then, even if there is a large amount of accesses (amount of I/O) from one logical partition to the system resource 190, a path is assigned to the logical partition with less amount of I/O, thereby enabling to avoid a holdup of the application process in this logical partition.

Therefore, according to the path assignment technique of the present invention, in the multipath system whereby the host computer having multiple logical partitions is connected to the system resource via multiple paths, and the multiple logical partitions share the system resource, I/O responsiveness can be ensured for the logical partitions with a small amount of I/O.

The exemplary embodiments of the present invention are described hereinafter based on the above principle.

### First Exemplary Embodiment

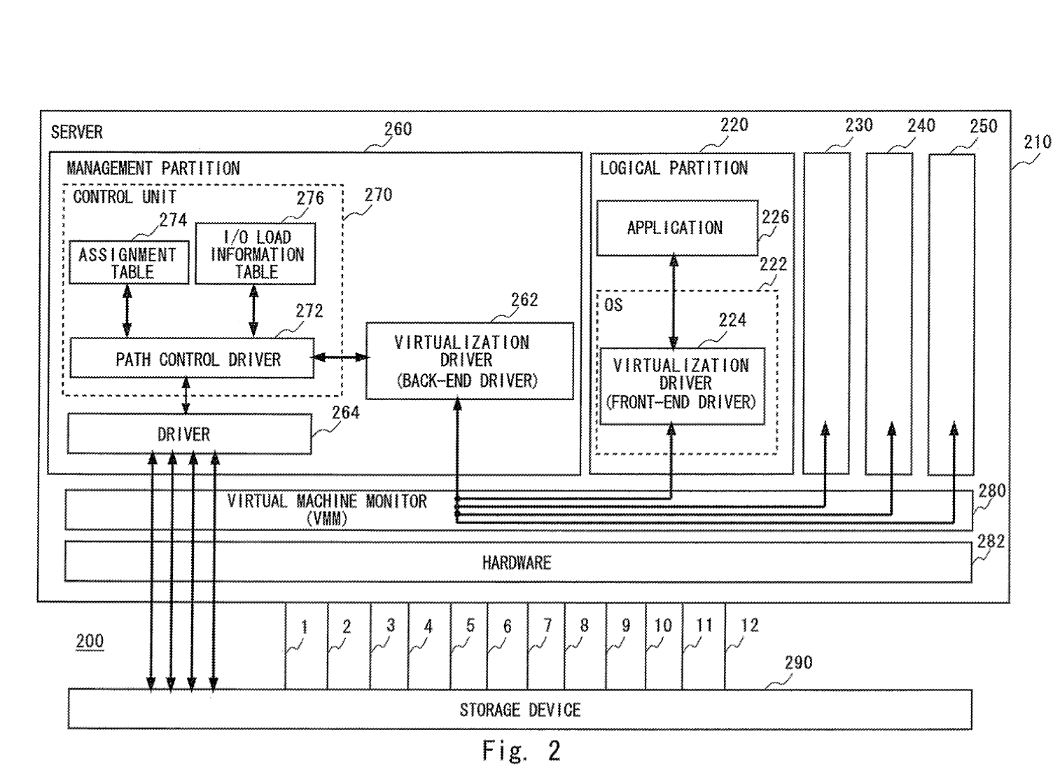

FIG. 2 illustrates a multipath system 200 according to a first exemplary embodiment of the present invention. The multipath system 200 is provided with a server 210, a storage device 290 used by the server 210, and multiple (for example 12) paths for connecting the server 210 and the storage device 290.

A virtual environment such as Hyper-V for Windows and Xen for Linux is implemented to the server 210 that includes multiple (for example 5) logical partitions configured for each OS. They are logical partitions 220, 230, 240, and 250, and a management partition 260 which manages the four logical partitions. The server 210 is further provided with a virtual machine monitor (VMM) 280 and hardware 282 for realizing the virtual environment.

An OS 222 and an application 226 are implemented to the logical partition 220. The OS 222 is provided with a virtualization driver (front-end driver) 224 for realizing the virtual environment. An OS and an application not illustrated are implemented to the logical partitions 230, 240, and 250 as with the logical partition 220. Detailed explanation and illustration of the OS and the application are omitted here.

The management partition 260 implements a management OS and includes a virtualization driver (back-end driver) 262, a control unit 270, and a driver 264 for realizing the virtualization environment.

Except the control unit 270, each component of the server 210 corresponds to the components of the host computer having similar virtual environment, thus only the control unit 270 is described in detail.

The control unit 270 includes a path control driver 272, an assignment table 274, and an I/O load information table 276. The control unit 270 also serves as the assignment unit 130 of the host computer 110 in the multipath system 100 illustrated in FIG. 1. The control unit 270 is provided with the function to assign the paths 1 to 12 to the logical partitions 220 to 250 and map the driver 264 and the virtualization driver 262, and the function to duplicate paths.

For each of the logical partitions 220 to 250, the assignment table 274 associates the information indicating the logical partition with the information that could indicate the number of paths to assign to the logical partition indicated by the corresponding information.

In the multipath system 200, the path control driver 272 creates the assignment table 274 that can be modified by the path control driver 272 later on. In this exemplary embodiment, as the information that could indicate the number of paths to assign to the logical partition, information indicating the path, for example a path ID, is used.

The path control driver 272 creates the assignment table 274 at the time of initializing the multipath system 200 to satisfy the following two conditions.

1. At least m number of paths are assigned to one logical partition. Further, m is an integer of more than or equal to 1 and less than the total number of paths (12 in this example). In this exemplary embodiment, m is 2, so as to provide a duplication function of the path for each logical partition.

Accordingly, in this exemplary embodiment, at least 2 paths are assigned to one logical partition. Note that the “duplication function” is the function to keep at least one of the paths as a sub path and use the sub path in case of a failure generated in any of the main path.

2. Assign more paths to a logical partition with a higher priority

The “priority” here indicates the priority in terms of ensuring the I/O responsiveness of the logical partition. The priority may be specified by a user or may be based on the kind of OS of the logical partition or kind of processes the logical partition is responsible for.

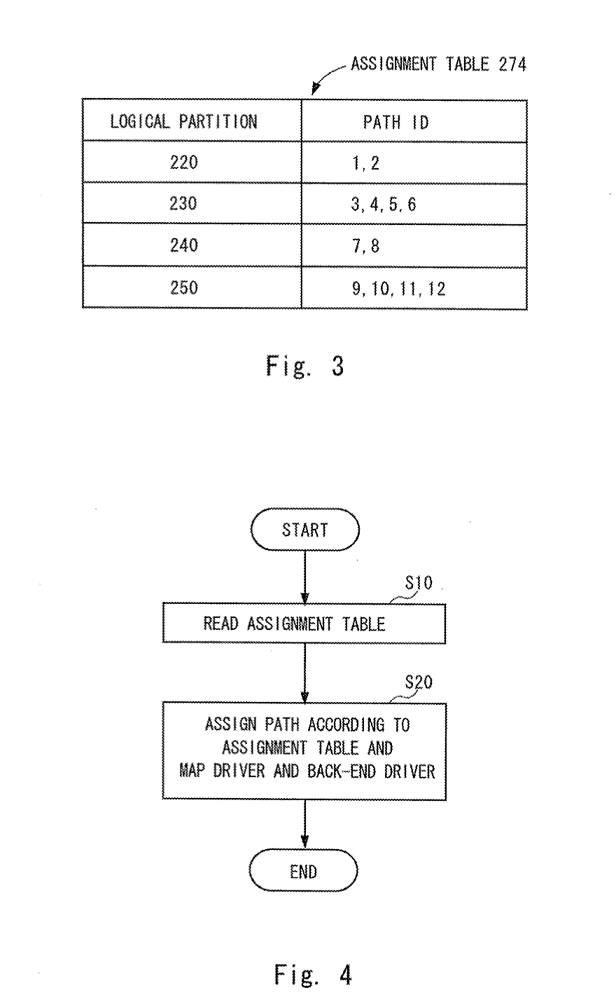

FIG. 3 illustrates an example of the assignment table 274 created by the path control driver 272. This is an example in case the logical partitions 230 and 250 have higher priorities than the logical partitions 220 and 240. As illustrated in FIG. 3, at least 2 paths are associated with each logical partition. Further, the logical partitions 230 and 250 with higher priorities are associated with more paths than the logical partitions 220 and 240 with lower priorities.

In this exemplary embodiment, the path control driver 272 carries out the process to update the assignment table 274 later on. The path control driver 272 assigns paths to each logical partition according to the assignment table 274 till the update process. For example, if the current assignment table 274 is the example illustrated in FIG. 3, the path control driver 272 assigns the paths 1 and 2 (2 paths) to the logical partition 220, the paths 3 to 6 (4 paths) to the logical partition 230, the paths 7 and 8 (2 paths) to the logical partition 240, and the paths 9 to 12 (4 paths) to the logical partition 250.

FIG. 4 is a flowchart illustrating the process of the path control driver 272 to assign paths to the logical partitions 220 to 250. If an I/O request is issued from any of the logical partitions, the path control driver 272 reads out the assignment table (S10), assigns the paths associated with the corresponding logical partition according to the assignment table 274, and maps the driver 264 and the visualization driver 262 (S20).

In order to update the assignment table 274, the path control driver 272 samples the amount of I/O issued by each logical partition and stores it to the I/O load information table 276. Note that as the amount of I/O, the number of issues of I/O for the corresponding logical partition or the load information such as the issued I/O size can be used, for example.

Then, the path control driver 272 updates the assignment table 274 according to the amount of I/O of each logical partition stored to the I/O load information table 276, for example at a constant interval. Note that the path control driver 272 updates the assignment table 274 to satisfy the following 2 conditions.

1. Assign at least 2 paths to one logical partition

2. Assign more paths to a logical partition with more amount of I/O

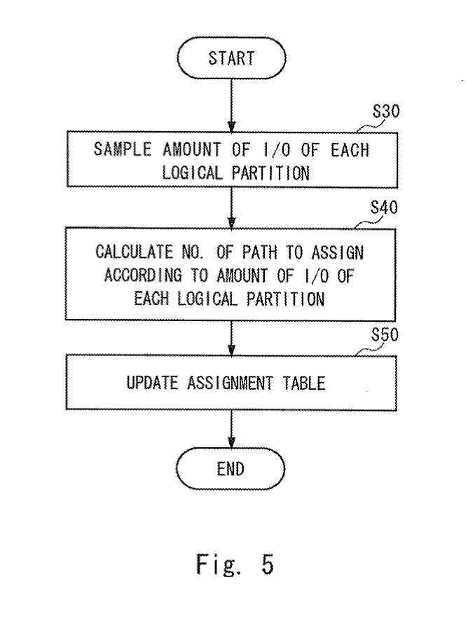

FIG. 5 is a flowchart illustrating the update process of the assignment table 274 by the path control driver 272. Note that the update process in FIG. 5 is carried out at a predetermined interval.

The path control driver 272 samples the amount of I/O of the logical partition 220, and stores it to the I/O load information table 276 (S30). The path control driver 272 reads out the I/O load information from the I/O load information table 276, calculates the number of paths to assign to each logical partition, and also updates the path control driver 272 using the calculated number of paths (S40 and S50).

The process of the step S40 carried out by the path control driver 272, that is, an example of an algorithm to calculate the number of paths to assign to each logical partition according to the amount of I/O of the logical partition, is explained hereinafter.

The path control driver 272 calculates the number of paths Pk to be assigned to each logical partition using the amount of I/O Sk of each logical partition stored to the I/O load information table 276 and the number of minimum paths MinPi to be assigned to each logical partition according to the equation (I). Note that the number of minimum paths MinPi is the minimum number of paths to assign even when I/O is not issued from the corresponding logical partition. In this exemplary embodiment, the same minimum number of paths m (2 in this example) is used for each logical partition.

$${P}_{k} = ⌊ n - {\sum }_{i = 1}^{N} min {P}_{i} ⌋ \times \frac{{S}_{k}}{S } \\ {P}_{k} \text{:} No . of paths to assign to logical partition k \\ n \text{:} Total no . of paths \\ N : Total no . of logical paritions \\ min {P}_{i} \text{:} Minimum no . of paths to assign to partition i \\ S = {\sum }_{i = 1}^{N} {S}_{i} \text{:} Total amount of I \text{/} O \\ {S}_{k} \text{:} Amount of I \text{/} O from logical partition k \\ ⌊ ⌋ \text{:} Gauss symbol ( round down ) \qquad ( 1 )$$

The total number of paths Pk calculated in accordance with the equation (1) is not necessarily the total number of paths. If the calculated number of paths Pk satisfy the equation (2), that is when there is no remaining path, the path control driver 272 updates the assignment table 274 with the calculated number of paths Pk according to the equation (1), and also assigns the paths to the logical partitions 220 to 250 according to the assignment table 274 till the next update.

$$n - {\sum }_{k = 1}^{N} {P}_{k} = 0 , \\ n \text{:} Total no . of paths \\ {P}_{k} \text{:} No . of paths to assign to logical partition k \\ N \text{:} Total no . of logical partitions \qquad ( 2 )$$

On the other hand, if the number of paths Pk calculated according to the equation (1) satisfies the equation (3), that is when there are remaining paths, the path control driver 272 adds the remaining paths one by one to the number of paths Pk of the logical partitions in an ascending order of the amount of I/O, and then updates the assignment table 274. After that, the path control driver 272 assigns the paths to the logical partitions 220 to 250 according to the assignment table 274 till the next update.

$$0 < n - {\sum }_{k = 1}^{n} {P}_{k} \leq N \\ n \text{:} Total no . of paths \\ {P}_{k} \text{:} No . of paths to assign to logical partition k \\ N \text{:} Total no . of logical partitions \qquad ( 3 )$$

The multipath system 200 of this exemplary embodiment realizes the multipath system 100 of FIG. 1 and achieves all the effects acquired by the multipath system 100.

Further, in the multipath system 200 of this exemplary embodiment, the path control driver 272 assigns more paths to the logical partition with a higher priority. This enables to improve the I/O performance of the entire system and thus achieving a flexible operation.

Moreover, after an actual operation is started, the path control driver 272 assigns more paths to the logical partition with more amount of I/O for each logical partition. This optimizes the path assignment depending on the actual I/O status of the logical partitions and thus improving the I/O performance of the entire system.

### Second Exemplary Embodiment

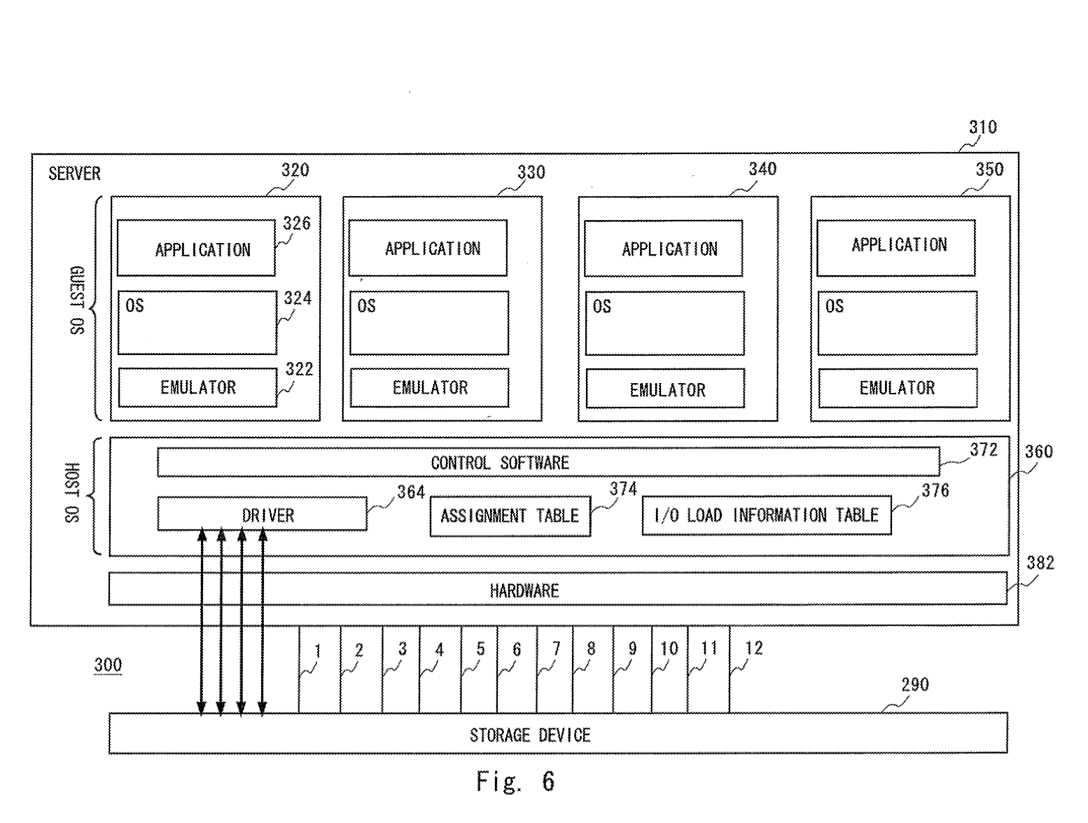

The path assignment technique of the present invention can be applied to a multipath system provided with a server that implements a guest OS/host OS virtual environment. This is explained with reference to FIG. 6.

FIG. 6 illustrates a multipath system 300 according to a second exemplary embodiment of the present invention. The multipath system 300 is provided a server 310, a storage device 290 used by the server 310, and multiple (12 in this example) paths for connecting the server 310 and the storage device 290.

A guest OS/host OS virtual environment is implemented to the server 310, which is provided with a host OS 360, multiple (4 in this example) guest OSs 320 to 350, and hardware 382.

The guest OS 320 implements an emulator 322, an OS 324, and an application 326. The guest OSs 330, 340, and 350 have similar configuration as the guest OS 320. Thus detailed explanation and illustration are omitted here.

The host OS 360 is provided with a driver 364, control software 372, an assignment table 374, and an I/O load information table 376.

The components of the server 310 are similar to the components of the host computer having the same kind of virtual environment except a part of the control software 372, the assignment table 374, and the I/O load information table 376.

The control software 372 assigns the paths 1 to 12 to each guest OS according to the assignment table 374 and the I/O load information table 376. The assignment of the paths are carried out in a similar manner as the path control driver 272 in the multipath system 200. Further, the assignment table 374 and the I/O load information table 376 are same as the assignment table 274 and the I/O load information table 276 in the multipath system 200, respectively.

Accordingly, the technique of the present invention can be applied to a multipath system having a server and a storage device being connected via multiple path, and the server having guest OS/host OS virtual environment.

The same effect as the multipath system 200 can be achieved by applying the technique of the present invention.

The present invention is described using the exemplary embodiments. The exemplary embodiments are illustrative only, and various modification, subtraction, and addition may be made within the scope of the present invention. Those skilled in the art will recognize that such modification, subtraction, and addition are within the scope of the present invention.

For example, in the multipath system 200 illustrated in FIG. 2, the minimum number of paths to assign to each logical partition for the path control driver 272 is uniformly m(2). However the minimum number of paths to assign to the logical partitions may be increased for the logical partition with a higher priority.

Further, in the multipath system 200, the number of paths to assign to each logical partition is determined according to the priority of the logical partitions. After that, the number of paths is determined according to the amount of I/O of each logical partition. However, as long as the number of paths to assign to each logical partition will not be less than or equal to the minimum number of paths of the logical partition, the number of paths to assign may be determined according only to the priority or only to the amount of I/O, for example.

It is needless to say that as long as the number of paths to assign to each logical partition will not be less than or equal to the minimum number of paths of the logical partition, I/O responsiveness can be ensured for the logical partition with less amount of I/O without consideration over the priority and the amount of I/O.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A host computer that is connected to a system resource via n (n>=2) number of paths, comprising:
a plurality of logical partitions accessible to the system resource; and
an assignment unit that assigns the paths to the plurality of logical partitions,
wherein the assignment unit assigns at least m (1<=m<n) number of paths to one logical partition.

2. The host computer according to claim 1, wherein the assignment unit assigns more paths to the logical partition with more accesses to the system resource.

3. The host computer according to claim 1, wherein the assignment unit assigns more paths to the logical partition with a higher priority.

4. The host computer according to claim 1, wherein the m is an integer more than or equal to 2.

5. The host computer according to claim 1, wherein the plurality of logical partitions are configured for each of a plurality of OSs (operating Systems).

6. The host computer according to claim 1, further comprising a guest OS/host OS virtual environment, wherein
the plurality of logical partitions are configured for a plurality of the guest OSs, and
the assignment unit is provided to the host OS side.

7. The host computer according to claim 2, further comprising a guest OS/host OS virtual environment, wherein
the plurality of logical partitions are configured for a plurality of the guest OSs, and
the assignment unit is provided to the side of the host OS.

8. The host computer according to claim 3, further comprising a guest OS/host OS virtual environment, wherein
the plurality of logical partitions are configured for a plurality of the guest OSs, and the assignment unit is provided to the side of the host OS.

9. The host computer according to claim 4, further comprising a guest OS/host OS virtual environment, wherein
the plurality of logical partitions are configured for a plurality of the guest OSs, and the assignment unit is provided to the side of the host OS.

10. A multipath system comprising:
the host computer of claim 1;
the system resource; and
the n (n>=2) number of paths for connecting the host computer and the system resource.

11. A multipath system comprising:
the host computer of claim 2;
the system resource; and
the n (n>=2) number of paths for connecting the host computer and the system resource.

12. A multipath system comprising:
the host computer of claim 3;
the system resource; and
the n (n>=2) number of paths for connecting the host computer and the system resource.

13. The multipath system according to claim 10, wherein the system resource is a storage device.

14. The multipath system according to claim 11, wherein the system resource is a storage device.

15. The multipath system according to claim 12, wherein the system resource is a storage device.

16. A method comprising:
assigning paths to a plurality of logical partitions accessible to a system resource, the logical partitions being provided to a host computer connected to the system resource via n (n is an integer more than or equal to 2) number of the paths,
wherein at least m (1<=m<n) number of the path is assigned to one logical partition.

17. The method according to claim 16, wherein the path assignment process is performed in a way that more paths are assigned to the logical partition with more accesses to the system resource.

18. The method according to claim 16, wherein the path assignment process is performed in a way that more paths are assigned to the logical partition with a higher priority.

19. A program product for directing a computer to execute a path assignment process comprising:
assigning paths to a plurality of logical partitions accessible to a system resource, the logical partitions being provided to a host computer connected to the system resource via n (n is an integer more than or equal to 2) number of the paths,
wherein the path assignment process is performed in a way that at least m (1<=m<n) number of path is assigned to one logical partition.

20. The program product according to claim 19, wherein the path assignment process assigns more paths to the logical partition with more accesses to the system resource.

21. The program product according to claim 19, wherein the path assignment process assigns more paths to the logical partition with a higher priority.
